(19) United States
(12) Patent Application Publication
(10) Pub. No.: US 2005/0137746 A1
(43) Pub. Date: Jun. 23, 2005

(54) System and method for communication between an industrial robot and a tpu

(75) Inventors: Erik Carlson, Nedsoddtangen (NO); Jan Endresen, Asker (NO); Svein Johannessen, Oslo (NO)

Correspondence Address: VENABLE, BAETJER, HOWARD AND CIVILETTI, LLP, P.O. BOX 34385, WASHINGTON, DC, 20043-9998, US

(73) Assignee: ABB AB, Vasteras (SE)

(21) Appl. No.: 10/493,628

(22) PCT Filed: Oct. 20, 2002
(86) PCT No.: PCT/SE02/01898

(30) Foreign Application Priority Data
Oct. 23, 2001 (SE) 0103532-8

(51) Int. Cl. G06F 19/00

(52) U.S. Cl. 700/245

(57) ABSTRACT

An industrial robot comprising a manipulator (2), a control unit (3) for controlling the manipulator, a portable operating unit (4) for reaching an manually operating the robot, which operating unit is adapted for communication with the control unit and comprising a operator control means (9).

### TECHNICAL FIELD

The present invention relates to an industrial robot system, including a manipulator and a control unit having means for automatically operating the manipulator. A portable operator control device is connected to the control unit having means for teaching and manually operating the manipulator. The invention also relates to a method for communication in an industrial robot system. Especially the invention relates to a communication control. Particularly the invention relates to a wireless teach pendant unit.

An operator control device is a portable operator control device denoted a teach pendant unit, TPU, in the following. A TPU normally comprises operator control means and a visual display unit. The operator control means usually is a joystick, a ball, a set of buttons or any combination of these.

### BACKGROUND OF THE INVENTION

An industrial robot is programmed to carry out work or a work cycle along an operating path. In order to program or teach the robot the work cycle, the robot is manipulated to positions along the desired operating path. These positions are stored as instructions in a memory in the control unit. Other information, such as desired robot movement velocity, may also be stored in the memory. During operation of the robot, the program instructions are executed, thereby making the robot operate as desired. A robot is operated in at least two modes: automatic and manual. By switching a mode selector key on a control panel on the control unit, the choice of mode, in which the robot shall operate, is made. When the robot is in the manual mode, the TPU has the exclusive right to operate the robot and thus no other operating control device or control unit is allowed to control the robot.

An industrial robot is usually placed in robot cells in order to facilitate the automation of a complex series of actions under safe conditions. When one of the robots in a robot cell is to be operated under manual control using a TPU, it is important that the TPU is communicating with and controlling the right robot. Thus, in order to accomplish a safe control of an industrial robot, it is important to have absolute confidence in the control of the robot. The operator must be fully aware of the current mode of the connection between the control unit and the TPU.

In an industrial robot system where the TPU is connected to the control unit by a cable, the operator can easily be aware of the current mode of said connection. The cable is preferably shielded and no other communication systems can interfere with the two connected units. Under normal conditions the control unit periodically transmits data to the TPU. Upon receiving this data the TPU responds by transmitting a response signal back to the control unit. Thus the control unit asks the TPU if this is in operation. The control unit judges from said response signal if the TPU is in normal condition. If the emergency switch has been activated the response signal carries that information and the control unit executes the emergency stop. The length of the cable defines the maximum distance between a TPU cable connected to an industrial robot and the control unit.

In an abnormal situation, e.g. when the operating unit is disconnected or the cable is cut off, the TPU does not transmit a responding signal. The absence of a responding signal is a sign to the control unit that there is an emergency stop situation and the emergency stop will be activated.

However, the TPU cable end up entangled on the floor in industrial robot systems with several robots and hence several cables. The cables are often lying on the floor and there is an obvious risk of damage by a vehicle running over. There is also a risk of cable entanglement by which an operator will have difficulties in knowing which TPU belongs to which robot. Furthermore, a TPU connected by cable to a control unit limits the degree of freedom that an operator needs to perform an effective operation with the robot.

In accordance with the conditions mentioned above, the development of industrial robot systems is in one way leading to a wireless TPU for the robot control. A wireless connection eliminates most of the negative consequences of using a cable connection. On the other hand, a wireless connection introduces some problems of its own. Most notably is the problem of ensuring that the TPU is associated with the correct robot and the problem of verifying that the wireless connection works correctly.

In both cases, there is a risk of personal injury if the operator believes that he is operating and controlling a certain robot but instead is out of contact with this particular robot. Thus, there is a strong need to ensure connection between the robot and the TPU when using a TPU not physically connected to the robot. In other words, it is of great importance that the operator is immediately made aware of a sudden communication loss of the TPU. Since the operator usually is concentrated on the robot and there may be a great deal of ambient noise, the usual warnings (blinking light, buzzer) are ineffective and not reliable.

One security arrangement in an industrial robot system with a robot working in a cell is designed as follows. If something abnormal happens in the cell, an emergency stop is activated and the operating robot is stopped and remains standing still. After reestablishment of a normal condition in the cell, the robot will be restarted. In this situation, a stopped robot does not disturb the rest of the robot system. Then, there is a higher degree of security stop and that is the emergency stop for stopping the whole robot system. This is activated when something extraordinary happens somewhere in the robot system. Closing down the whole robot system is undesirable since it necessitates a great deal of work for the operator to return the system to operation conditions.

From the Japanese patent application 11-73201 a wireless control system is previously known. The object of the invention is to provide a communication system wherein the specific communication of emergency stop control can be carried out by wireless means in a manner equivalent to cable communication. The solution of the invention is in the design of the system with data exchange by means of wireless or optical communication between a first device and a second device. The first device comprises a transmitting part and a receiving part. The second device comprises a receiving part and a transmitting part, which returns arbitrary data in response to data received from said first device at a normal time, and stops said response at an abnormal condition. The first device judges the condition to be abnormal by recognizing the received data to be arbitrary data. It also judges the condition to be normal by recognizing the received data to be specific data. Thus, specific communications such as emergency stop control is carried out by wireless means in a manner equivalent to the prior cable communication, and the system is made fail-safe.

A wireless connection is less predictable than a wired connection, and the communication between the TPU and the control unit may fail, be loosed or be broken by the system due to either distance, signal interference, radio shadows, current interruptions or battery failure, all of which will cause a communication loss. All different communication losses are denoted “a broken data link” and all different operating communications are denoted “a connected data link” in the following.

If a broken data link occurs, arrangements required by safety regulations will immediately stop the robot. These security arrangements are further programmed to measure the time for the robot standing still in accordance with the situation mentioned above. When the robot has been standing still for a predetermined time due to the broken data link, the emergency stop is activated and all activities in the cell will be stopped. The time between these events is chosen in order to comply with the safety regulations in force.

Despite necessity of security systems, a sudden shutdown of a robot system is a very frustrating situation for the operator. It requires time and energy for realizing the situation. It also takes a great deal of effort and time to reestablish the working condition in the robot system. This is a situation every operator is anxious to avoid, especially when there is no reason for the stop.

According to the conditions mentioned above, there is a need for an industrial robot system containing a TPU, which system has the function of immediately making an operator aware of a broken data link. More precisely, there is a need for a TPU, which has the character of immediately indicating a broken data link to an operator carrying the TPU.

### SUMMARY OF THE INVENTION

The object of the invention is to facilitate the work with a portable operator control device, for operating an industrial robot system, defined above. A second object of the invention is to provide an industrial robot system with increased access for the operator without limiting the security. A third object of the invention is to submit an industrial robot system with increased operation safety.

These objects are achieved according to the invention in a first aspect with an industrial robot system comprising the characteristic features of the independent claim 1, in a second aspect with a portable TPU comprising the characteristic features of the independent claim 9 and a third aspect with a method for controlling an industrial robot system comprising the characteristic features of the independent claim 23. According to the invention, these objects also are achieved in a data program product comprising the characteristic features of the independent claim 34, and a use of the method according to claims 37. Preferred embodiments are described in the dependent claims.

According to the invention, one or a plurality of robots are controlled by one TPU unit. Each TPU is communicating with the control unit only locally. There is a limit built into the system as to how far from the control unit a TPU is allowed to operate. Thus, there is a maximum operating distance for the TPU, which distance usually varies in different directions around the control unit. Often, the maximum distance involves intervals defined not to allow operation. Therefore, distances together with directions define one or a plurality of work areas within which the TPU is allowed connection to the control unit under secure conditions. These distances, directions and defined areas are invisible but an important security limitation since an operator has difficulties in knowing where to be positioned.

When an activated TPU is moved away from the control unit longer than the mentioned maximum operating distance, the system is programmed to break the connection to the control unit. Thus, if an operator, bringing a wireless TPU connected to the robot, is walking too far away from the control unit, the control unit will break the data link to the TPU. The data link will also be broken when the TPU positioned in a defined work area A suddenly passes the border into the exterior area. Thus, it is an object of the invention to connect/disconnect a TPU due to the exact position of the TPU.

The solution according to the first aspect of the invention is to provide an industrial robot system with at least one industrial robot comprising a manipulator, a control unit for controlling the manipulator, a portable operator control device, TPU, for teaching and manually operating the robot. The TPU is adapted for communication with the control unit via a data link. The TPU comprises indicating means arranged to indicate a broken data link through tactile feedback by touch perception to the body of an operator bringing the control device during operation. Consequently, the operator bringing a TPU according to the invention will notice the disconnection of the TPU and has the possibility to reenter the operating distance before the emergency stop for stopping the whole robot system is activated.

According to one embodiment of the invention, the data link in the industrial robot system is a wireless data link. In another embodiment of the invention, the link is a radio link connected to and communicating through a network. In yet another embodiment, the TPU comprises a unit sold under the name of Bluetooth.

According to the invention, indicating means is arranged in the TPU for indication of a broken data link through tactile feedback by touch perception to the body of the operator. According to the invention, the indicating means is either an active or a passive indicating means. The operator is usually carrying the operator control device and both the active and passive indication through physical perception is a tactile feedback to the hand.

An active indicating means is defined to create a mechanical force, which transfers information to an operator, without the operator asking for it. In one embodiment of the invention, the active indicating means comprises vibrating means operable to vibrate due to a broken data link. In another embodiment, the vibrating means is included in the TPU. In another embodiment, the vibrating means is included in an operator control means. In yet another embodiment, the operator control means is a joystick operable to vibrate due to a broken data link.

A passive indicating means is defined to create a mechanical movement reaction, which is arranged to be stiffer or looser upon indication. According the invention, the passive indicating means is included in an operator control means. In one embodiment, the operator control is arranged to introduce a mechanical resistance to movement during operation, when the data link is communicating in a normal way. Upon a broken data link, the passive indicating means is arranged to loosen or stiffen the resistance to movement in the operator control means. The operator control means is usually a joystick, a ball or a set of buttons. In one embodiment of the invention, the operator control means is a joystick and the passive indicating means comprises resilient means operable to introduce a mechanical resistance to manual movement of the joystick. In this embodiment, a passive indication comprises a loosening of the mechanical resistance in the joystick.

In one embodiment, the mechanical resistance is created by a spring-loading resilient means included in the indicating means. Resilience control means is arranged to control the spring-loading force of the resilient means. In one embodiment of the invention, the resilience control means comprises at least one regulating means arranged to regulate the spring-force of the resilient means. In another embodiment of the invention the, regulating means comprises a non-elastic thread arranged as a mechanical connection between the regulating means and the resilient means. The regulating means comprises tightening means arranged to tighten/loosen the thread in the regulating means and establish the mechanical movement reaction of the indicating means. In yet another embodiment of the invention, the passive indications means comprises magnetic means operable to introduce a mechanical resistance to movement of the operator control means.

In one embodiment of the invention, the data link is operable due to both a steady stream of command messages from the control unit to the TPU and messages in response from the TPU back to the control unit.

In another embodiment of the invention, the data link is operable due to both a steady stream of command messages from the TPU to the control unit and messages in response from the control unit to the TPU.

In yet another embodiment of the invention, the data link is operable within one or a plurality of defined work areas A.

The solution according to the second aspect of the invention is to provide a portable TPU for teaching and manually operating a manipulator in an industrial robot system, comprising a control unit. The TPU is adapted for communication with the control unit via a data link. The TPU comprises indicating means, which is arranged to physically indicate a broken data link by touch perception to the body of an operator bringing the TPU during operation.

According to the invention, the TPU and the control unit are communicating via a cable or a wireless data link. In one embodiment of the invention, the link is a radio link connected to and communicating through a network. In yet another embodiment, the TPU comprises wireless communication means known under the name of Bluetooth. Moreover, the portable TPU comprises the same characteristic features as the TPU provided for in embodiments of the first aspect of the invention.

The solution according to the third aspect of the invention is to provide a method for control of an industrial robot system with an industrial robot comprising a manipulator, a portable TPU and a control unit comprising a processor. The TPU communicates with the control unit via a data link for manually programming and operating the manipulator. Upon a broken data link, an indicating means is activated to draw attention to the broken data link by touch perception of the body of the operator. Upon connection reestablishment, the indicating means is deactivated to cease the touch perception of the body of the operator.

According to the invention, the TPU and the control unit are communicating via a cable or a wireless data link. In one embodiment of the invention, the link is a radio link connected to and communicating through a network. In yet another embodiment, the TPU comprises wireless communication means known under the name of Bluetooth.

In one embodiment of the method according to the invention, the data link is communicating due to both a steady stream of command messages from the control unit to the TPU and messages in response from the TPU back to the control unit.

In another embodiment of the method according to the invention, the data link is communicating due to both a steady stream of command messages from the TPU to the control unit and messages in response from the control unit to the TPU.

According to the methods mentioned above, a broken data link is due to a broken stream of command messages or is due to a broken stream of response messages. In another method according to the invention, the data link is broken due to an instruction from the control unit.

In one embodiment of the invention, the TPU communicates via a wireless data link. Indicating means is actively or passively indicating a broken data link through tactile feedback by touch perception of the body of the operator.

The security arrangements are programmed to in some way accept the TPU getting closer to the control unit within said chosen time limit. Consequently, if the TPU comes close enough to the control unit in due time, the emergency stop will be reset and the robot reactivated. Then, the operator has the possibility to avoid a sudden shutdown of the robot system.

### BRIEF DESCRIPTION OF THE DRAWING

The invention will be explained more closely by the description of different embodiments thereof and with reference to the appended drawing in which:

FIG. 1a is a communication system according to the invention with a cable connected TPU,

FIG. 1b is a TPU according to the invention provided for wireless communication,

FIG. 2 shows a TPU, comprising vibrating means in accordance with the invention,

FIG. 3 shows a TPU including vibrating means integrated in a joystick.

FIG. 4 schematically shows a cross section of a joystick comprising four resilient means in accordance with the invention,

FIG. 5 shows the joystick of FIG. 4 comprising resilience control means and providing mechanical resistance to movement in accordance with the invention,

FIG. 6 shows the joystick in FIG. 5 in a relaxed position lacking mechanical resistance to movement in accordance with the invention,

FIG. 7 schematically shows a cross section of a joystick comprising a resilient means including a regulating means creating mechanical resistance to movement of the joystick.

FIG. 8 shows the joystick in FIG. 7 in a relaxed position lacking mechanical resistance to movement.

FIG. 9 schematically shows a cross section of a joystick comprising magnetic means creating magnetic resistance to movement of the joystick.

FIG. 10 schematically shows a cross section of a joystick comprising two electric motors arranged perpendicularly, creating magnetic resistance to movement of the joystick.

### DESCRIPTION OF THE PREFERRED EMBODIMENTS

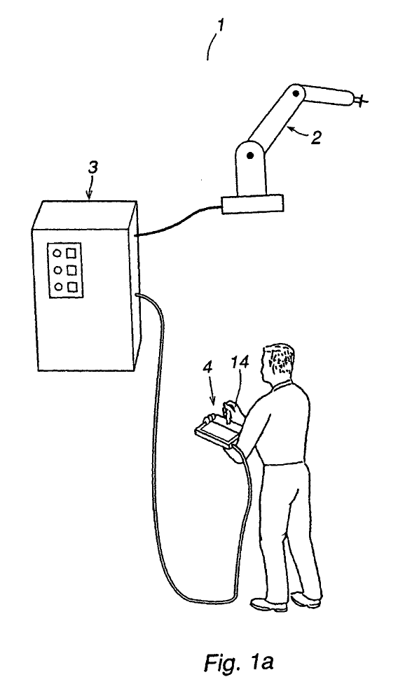

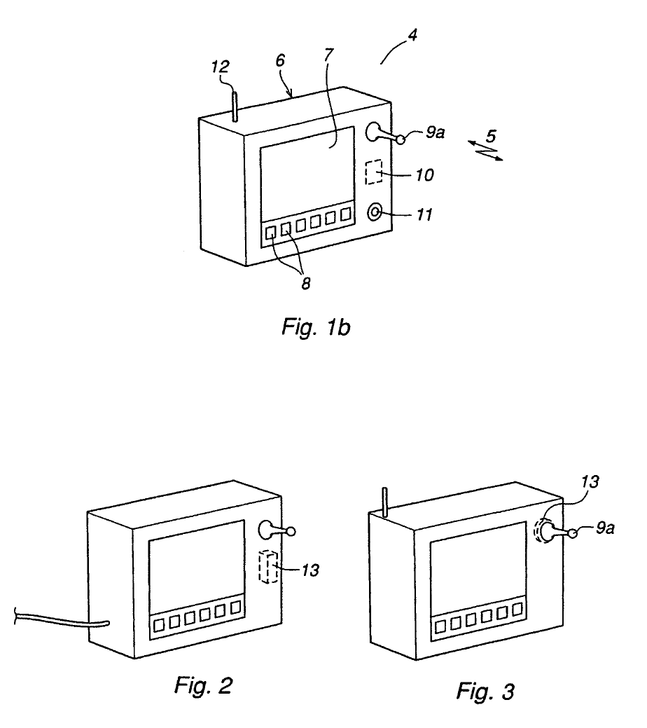

FIG. 1 is a communication system comprising an industrial robot 1, including a manipulator 2 and a control unit 3 for controlling the manipulator. A TPU 4, for teaching and manually operating the manipulator, is communicating with the control unit 3 via a cable connected data link 5. FIG. 1b is a TPU according to the invention, which comprises a portable box 6 including a display means 7, function keys 8, a joystick 9a, indicating means 10 and an emergency stop device 11. The TPU includes an antenna 12 for wireless communication with the control unit 3. The indicating means 10 is arranged to actively or passively indicate to the operator a broken data link 5.

FIG. 2 is a TPU, including active indicating means 10a, which comprises vibrating means 13, arranged, integrated in the TPU. Upon a broken data link 5, the active indicating means 10a is activated and the vibrating means 13 starts to vibrate. This vibration is, during operation, an active indication to the operator that the data link 5 is broken. This tactile feedback is brought by touch perception to the body of an operator bringing the TPU.

FIG. 3 is a TPU in which the active indicating means 10a comprises vibrating means 13 arranged integrated in a joystick 9a. Upon a broken data link, the vibrating means 13 is arranged to start vibrating. This vibration is an active indication to the body of the operator that the data link is broken. The embodiments shown in FIGS. 1 and 2 also include vibration control means 18 (not shown).

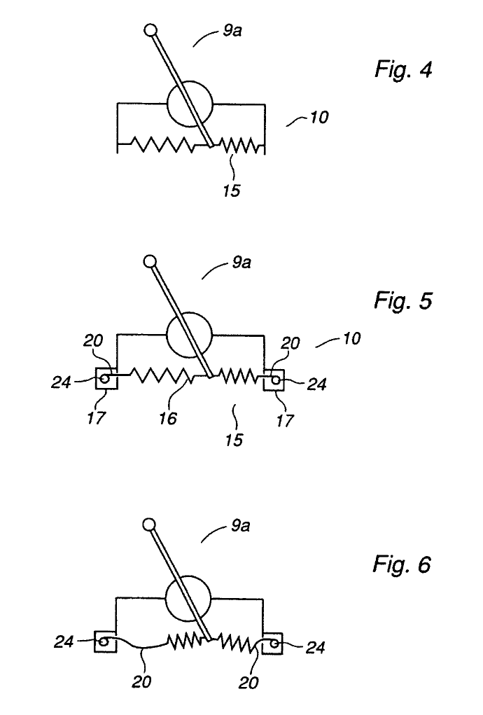

FIG. 4 is a joystick 9a including passive indicating means 10b, schematically shown. The passive indicating mean 10b is integrated in the joystick 9a and is arranged to introduce a mechanical resistance to manual movement of the joystick. The passive indicating means 10b comprises resilient means 15 arranged to passively indicate to the operator a broken data link by a mechanical movement reaction created by loosening or stiffening of the mechanical resistance.

FIG. 5 is a joystick 9a according to the invention including passive indicating means 10b comprising resilient means 15 in the form of four “horizontal” helical springs 16 and four resilience control means 17. A non-elastic thread 20 is arranged as a mechanical connection between the resilient means 15 and the resilience control means 17. The resilience control means 17 comprises at least one regulating means 19 arranged to regulate the spring force of the resilient means 15. The regulating means is arranged to tighten the thread to realize the force feedback in the joystick due to a communicating data link and to relax the thread to reduce the mechanical resistance due to a broken data link. The regulating means 19 is arranged to tighten or loosen the thread 20 by means of an energy supply 22 in order to create a mechanical movement reaction, which is arranged to be stiffer or looser upon indication. The energy supply 22 is a small motor 23 winding and unwinding the thread 20 on an axle 24. When the battery is fully discharged, the axle 24 is locked and prevented from rotating.

FIG. 6 is a joystick with the resilient means creating a looser mechanical movement reaction and thereby indicating a broken data link.

In one embodiment, the indication of a broken data link is combined with a light signal arranged visible for the operator on the exterior of the TPU (not shown).

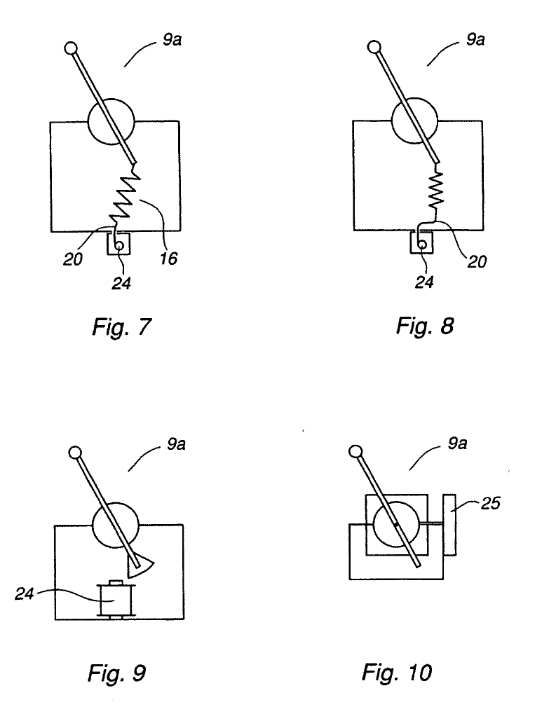

FIG. 7 is a joystick 9a, which comprises one helical spring 16 arranged vertically and provided with a thread 20 connecting the helical spring and a resilience control means 17. In this embodiment, the mechanical resistance to movement is provided for by means of only one helical spring. In FIG. 7 the joystick is arranged to create a mechanical movement reaction, which is arranged to be looser upon indication. In FIG. 8, the joystick is indicating a broken data link through the relaxed thread 20.

The passive indicating means comprising resilient means is provided with a spring force for returning the actual operator control means to the initial position.

In one embodiment, the spring-loaded force is created by magnetic means 23. The magnetic means is either a permanent magnet 24a (not shown) or an electromagnet 24b. FIG. 9 is a joystick comprising an electromagnet 24b creating magnetic resistance to movement of the joystick. FIG. 10 shows a joystick comprising two electric motors 25 (one not shown) arranged perpendicularly, creating magnetic resistance to movement of the joystick.

While only certain preferred features of the present invention have been illustrated and described, many modifications and changes will be apparent to those skilled in the art. A modification is to implement the tightening/relaxing of the thread by means of a screw and a screw gear. Another modification is to implement the tightening/relaxing of the thread by means of a rack-and pinion gear. Yet another modification is that a solenoid tightens the thread when under power. It is therefore to be understood that all such modifications and changes of the present invention fall within the scope of the claims.

1. An industrial robot system comprising at least one industrial robot including a manipulator, a control unit for controlling the manipulator, a portable operator control device, TPU, for teaching and manually operating the robot, which TPU is adapted for communication with the control unit via a data link wherein the TPU comprises indicating means arranged to indicate a broken data link through tactile feedback by touch perception to the body of an operator carrying the TPU during operation.

2. The industrial robot system according to claim 1, wherein the data link is a wireless data link.

3. The industrial robot system according to claim 2, wherein the wireless data link is a radio link communication connected to a network.

4. Industrial The industrial robot system according to claim 1, wherein the indicating means comprises active indication means operable to active indication to the operator of a broken data link.

5. The industrial robot system according to claim 1, wherein the TPU comprises an operator control means arranged to include the passive indicating means.

6. The industrial robot system according to claim 1, wherein the data link is operable due to both a steady stream of command messages from the control unit to the TPU and messages in response from the TPU back to the control unit.

7. The industrial robot system according to claim 6, wherein the data link is operable due to both a steady stream of command messages from the TPU to the control unit and messages in response from the control unit to the TPU.

8. The industrial robot system according to claim 1, wherein the data link is operable within a defined area.

9. A portable operator control device, TPU, for teaching and manually operating a manipulator in an industrial robot system comprising a control unit, which TPU is adapted for communication with the control unit via a data link, wherein the operator control device comprises indicating means arranged to indicate a broken data link through tactile feedback by touch perception to the body of an operator bringing the TPU during operation.

10. The operator control device according to claim 9, wherein the data link is a wireless data link.

11. The operator control device according to claim 9, wherein the indicating means comprises active indication means operable to active indication to the operator of the broken data link.

12. The operator control device according to claim 11, wherein the active indicating means comprises vibrating means arranged to vibrate the operator control device to indicate to the operator a broken data link.

13. The operator control device according to claim 11, wherein the TPU comprises an operator control means arranged to include the active indicating means.

14. The operator control device according to claim 13, wherein the operator control means comprises the active indicating means.

15. The operator control device according to claim 14, wherein the active indicating means comprises vibrating means.

16. The operator control device according to claim 14, wherein the operator controls means is a joystick.

17. The operator control device according to claim 9, wherein the indicating means comprises passive indication means operable to passive indication to the operator a broken data link.

18. The operator control device according to claim 17, wherein the TPU comprises an operator control means arranged to include the passive indicating means.

19. The operator control device according to claim 18, wherein the passive indicating means comprises resilient means operable to introduce a mechanical resistance to movement of the operator control means.

20. The operator control device according to claim 19, wherein the resilient means includes at least one helical spring.

21. The operator control device according to claim 19, wherein the passive indicating means comprises resilience control means arranged to regulate the spring-force of the resilient means.

22. The operator control device according to claim 17, wherein the passive indicating means comprises magnetic means operable to introduce a magnetic resistance to movement of the operator control means.

23. A method for communication in an industrial robot system comprising an industrial robot including a manipulator, a control unit comprising a processor, for controlling the manipulator and a portable operator control device, TPU, which communicates with the control unit via a data link for manually operating the manipulator characterized in the following steps:
providing the TPU with an indicating means having a tactile feedback,
upon a broken data link, activating an indicating means, which indicates a broken data link to the operator through tactile feedback by touch perception to the body of the operator,
upon communication reestablishment, deactivating the indicating means, which ceases to indicate a broken data link to the operator through tactile feedback by touch perception to the body of the operator.

24. The method according to claim 23, wherein the data link is communicating due to both a steady stream of command messages from the control unit to the TPU and messages in response from the TPU back to the control unit.

25. The method according to claim 23, wherein the data link is communicating due to both a steady stream of command messages from the TPU to the control unit and messages in response from the control unit to the TPU.

26. The method according to claim 24, wherein the broken data link is due to a broken stream of command messages.

27. The method according to claim 24, wherein the broken data link is due to a broken stream of response messages.

28. The method according to claim 23, wherein the data link is broken due to an instruction from the control unit.

29. The method according to claim 23, wherein the data link is brought to communicate via a wireless connection.

30. The method according to claim 23, wherein active indicating means is brought to actively indicate a broken data link.

31. The method according to claim 23, wherein the active indicating means is brought to vibrate.

32. The method according to claim 23, wherein indicating means is brought to passively indicate a broken data link.

33. The method according to claim 23, wherein the indicating means is brought to establish a mechanical resistance to movement of an operator control means, comprised in the TPU.

34. A computer program product comprising instructions to be effectuated by a processor to control an industrial robot system in accordance with the method according to claim 33.

35. The computer program product according to claim 34 at least partly supplied over a network such as the Internet.

36. A computer readable medium containing a computer program product according to claim 34.

37. Use of an industrial robot system comprising at least one industrial robot including a manipulator, a control unit for controlling the manipulator, a portable operator control device, TPU, for teaching and manually operating the robot, which TPU is adapted for communication with the control unit via a data link wherein the TPU comprises indicating means arranged to indicate a broken data link through tactile feedback by touch perception to the body of an operator carrying the TPU during operation, and a method according to claim 23 for teaching welding operations.
